(19) United States
(12) Patent Application Publication
(10) Pub. No.: US 2005/0004948 A1
(43) Pub. Date: Jan. 6, 2005

(54) Facilitation of local, community-based, person-to-person connections and transactions on a national, international, or global scale

(76) Inventors: Rajesh Navar, Los Altos Hills, CA (US); Sunil Palacherla, San Jose, CA (US)

Correspondence Address: INNOVATION MANAGEMENT SCIENCES, P. O. BOX 1169, LOS ALTOS, CA, 94023-1169, US

(21) Appl. No.: 10/868,530

(22) Filed: Jun. 15, 2004

Related U.S. Application Data
(60) Provisional application No. 60/484,957, filed on Jul. 3, 2003.

(51) Int. Cl. G06F 17/30

(52) U.S. Cl. 707/104.1

(57) ABSTRACT

A business method and system described herein allows and promotes users to interact, meet face-to-face, and transact with other users located within the vicinity. Furthermore, the business method and system provides relevant local content to a user. Local content includes postings of items available within a certain distance of the user's community. Relevant local content includes postings of local content relevant to the categories browsed or searched by the user. Postings of items not available within a certain distance of the user's community may not be displayed. The business method and system also provides an Internet-based local forum for auctions, wherein local buyers can bid on an item put up for auction by a local seller.

### CLAIM OF PRIORITY

The present application claims priority to U.S. Provisional Patent Application bearing Ser. No. 60/484,957, filed Jul. 3, 2003, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates generally to electronic commerce and more particularly to a method of and system for facilitating localized, community-based, person-to-person connections and transactions for a large number of local markets on a national, international and/or global scale.

### BACKGROUND OF THE INVENTION

The Internet is a worldwide system of connected computer networks. The Internet enables computers of all kinds to communicate directly, as if they were part of one giant seamless global computing machine. The Internet is currently configured to join together large commercial communications services as well as thousands of university, government and corporate computer networks and other computers. The World Wide Web is a collection of Web pages and Web-sites that are accessible via the Internet by means of various communication protocols (e.g., HTTP, FTP). Communication over the World Wide Web may be interactive and is referred to as online.

There are currently online systems that allow users to post items for sale. Some Web-sites, such as Ebay.com, enable sellers to obtain fairly reasonable prices for their items through an online auction system. The success of online auction sites may be attributable to their global reach. A posting on Ebay.com, for instance, can reach virtually any potential buyers who have Internet access. Nevertheless, many people remain skeptical of buying and selling items through online auction sites. There may be many reasons for the skepticism. First, there is always a risk that the buying and selling parties, who are total strangers to each other, may not ship the item after receiving payment or may not pay after receiving the item. Second, the buyer cannot inspect or try out an item prior to purchasing it. Third, if the item is damaged during shipping or otherwise unacceptable, the buyer may not be able to return it. And even if he can return the item, he may have to incur additional shipping costs.

Furthermore, not every type of item is suitable for sale via online auction sites such as Ebay.com. In general, items having a high value-to-weight ratio can fetch higher prices when sold through Ebay.com than items having a low value-to-weight ratio. This is perhaps due to the high shipping cost, which can average more than 20% of the total transaction cost or higher for bulky items.

There are currently a few online services that allow sellers to connect to buyers at a local level. Those services typically involve online message boards on which sellers can post classified advertisements for items/services they offer and on which buyers can browse and search these advertisements. Those online message boards typically organize the classified advertisements first in terms of geographical location and then by category of the goods/services offered. Each geographical area has its own message board for posting classified advertisements, and item searching is limited to each individual message board. However, those services, which are available to large metropolitan areas, such as New York City, Los Angeles, and the San Francisco Bay Area, do not serve less densely populated area locations in the United States and international locations because it is impractical and ineffective to create a separate message board for each and every city and town in the world.

Heretofore, there has not been a method and system that facilitates local, community-based, person-to-person connections and transactions for a large number of locations, including those outside of major metropolitan areas, on a national, international and/or global scale.

### SUMMARY OF THE INVENTION

The invention provides a business method and system that facilitates and promotes users to interact, meet face-to-face, and transact with other users located within their vicinity by providing a Web-site on which users may post items for sale and on which users may browse or search the posted items. According to an embodiment of the invention, each item is associated with a community (e.g., a geographical location, an entity with which a group of people having something in common may be associated), and each user browsing or searching the Web-site may specify a community to which they belong. A user is able to view items associated with the user's community. Also, a user is able to view items associated with communities local to, or near, the user's community. However, users who belong to communities that are far away may not be able to view the item. The business method and system also enables an Internet-based local forum for auctions, wherein local buyers can bid on an item put up for auction by a local seller.

According to an embodiment of the invention, each posting of the online database is assigned a community identifier. A community identifier may be associated with a geographical area, such as a zip code or a town or city name. Also, a community identifier may be associated with an institution (e.g., a university), a corporate campus, a professional organization, a church, a temple, a military base, a computer user-group, or any entity with which a group of people may be associated. For example, when a student at Iowa State University posts an item on the database, the item may be tagged with a community identifier that is associated with the University. Alternatively, the item may be tagged with a community identifier that is associated with Ames, Iowa, the city in which the University is located and where the item may be available.

According to an embodiment of the invention, one community may be considered to be near another community when these communities are located within a certain distance from each other. In one embodiment, the distance may be set by the operator or owner of the Web-site. In one specific implementation, the distance is set to be fifty miles.

In one aspect, the business method and system of the invention may expand into a very large number of different local markets on a national and/or global scale. Local markets are effectively served regardless of whether they are located in metropolitan areas or more remote and less densely populated areas. Local markets in different countries may be served as well.

In another aspect, the business method and system of the invention is community-based. That is, the business method and system can be used to target a specific group of people with similar needs who associate themselves with something that is common to all within the group. In one embodiment, the business method and system allows a user to post an item on the Web-site and designate the item viewable by those who belong to a certain community, such as students and faculties of nearby colleges and universities. In this way, the posting may target a specific group of users more precisely than many other advertising methods. Furthermore, members of the targeted community will be able to view more relevant postings when they browse the Web-site with less distraction from irrelevant postings.

In yet another aspect, the business method and system of the invention facilitates many types of transactions and connections among users. For example, a user may post items for sale, items wanted, services for sale, services wanted, job listings, resumes, personal advertisements, etc.

One advantage of the business method and system of the invention is that it enables buyers to meet the sellers to inspect (e.g., touch and feel) the items posted on the Web-site before paying. The business method and system also enables buyers to pick up the item posted on the Web-site at the time of payment. This virtually eliminates the potential for fraud, which is inherent and unavoidable under globally-focused electronic commerce business models.

Another advantage of the business method and system of the invention is that shipping cost can be completely avoided, thus creating additional value to the buyer and the seller.

The business method and system of the invention further creates new markets for goods that could not be shipped before and items with a low value-to-weight ratio. Examples of such goods include, but are not limited to, used furniture, used cars, children's toys, etc. Services previously not available to be sold under globally-focused electronic commerce business models may be provided using the business model of the invention as well.

Yet another advantage of the business method and system of the invention is that, because items for sale can be picked up, they may be available to the buyer immediately.

In an embodiment, the business method and system of the invention provides a medium through which community members connect and make transactions within their local community. Implementing the business method and system does not require taking responsibility for any of the products or services listed in a community or the transaction, delivery, or exchange of the products or services. Rather, the business method and system acts as a broker or intermediary to facilitate transactions between users. The business method and process may include providing optional tools to facilitate communication or transactions between users, such as electronic mail, online messaging, online chat, online discussion boards, and the like. In addition, the business method and process may provide a feedback system to encourage members to provide feedback regarding transactions with other members.

### BRIEF DESCRIPTION OF THE DRAWINGS

The invention will now be described with reference to the accompanying drawings which illustrate example embodiments of the invention. Throughout the description, similar reference names may be used to identify similar elements.

FIG. 1 depicts a framework for using Internet technology to facilitate localized commerce in accordance with an embodiment of the invention.

FIG. 2 depicts a server for use in the framework of FIG. 1, in accordance with an embodiment of the invention.

FIGS. 3A-3C depict example database records for use in the framework of FIG. 1, in accordance with an embodiment of the invention.

FIGS. 4A-4D depict flowcharts of processes carried out by software modules of the server of FIG. 2, in accordance with embodiments of the invention.

FIG. 5 depicts communities that are local to each other according to an embodiment of the invention.

FIGS. 6A-6G depict screenshots from an example Web site according to an embodiment of the invention.

### DETAILED DESCRIPTION OF PREFERRED EMBODIMENTS

Various features of the invention, including specific implementations thereof, will now be described. Throughout the description, the term “item” will be used to refer generally to a saleable unit, whether a physical or digital object, a service, a transferable right, a license, or data that may have a range of attributes. The term “item” will also be used to refer generally to both something that may be purchased, and its record or description within a database (e.g., a mobile phone's description within a database). The term “item” will also be used to refer generally to an advertisement, such as an advertisement for service offered, service wanted, a job listing, a job wanted advertisement, and a personal advertisement. A more specific meaning may be implied by context. The term “product” is used in the same manner.

According to an embodiment, the invention provides a Web-site having an item database and acting as a browsable/searchable catalog of items. Sellers visiting the Web-site may post items for sale. An entry in the item database is called a “posting,” and the act of creating an entry in the item database is referred to as “posting an item.” In addition, the seller may be required to provide its location (e.g., a zip code), its address or other contact information. User information and records may be stored within a user information database of the Web-site.

In various places throughout the description, the term “community” refers to a group of people with similar needs who associate themselves with something that is common to all within the group. For example, college students may be considered a community, and college students attending Stanford University may be considered a community as well. Another example community may include military personnel working at a military facility and their families, as well as businesses and residents living in or around the military facility. Yet another example community may include the employees of a corporate entity and their families, as well as businesses and residents living in or around the corporate entity. These communities are not intended to represent an exhaustive list to which the invention pertains, but rather, they are merely examples of the types of potential communities within the scope of the present disclosure. The term “community” may also refer to the people living in particular area, the body of people in a learned occupation, or an association of people with similar interests. Other meanings of the term “community” may be implied by context.

As used herein, the term “community” also refers to an organization, entity or region with which a group of people is associated. For example, Stanford University, which is an entity with which students, faculty, staff and those living nearby are associated, is considered a community. An army base is considered a community, and a corporate campus is also considered a community. Cities and towns may be considered “communities” as well.

The term “reach” herein refers to a number of interested parties a posting can generate. More specifically, an item's reach refers to a number of potentially interested buyers or sellers who will see the posting of the item.

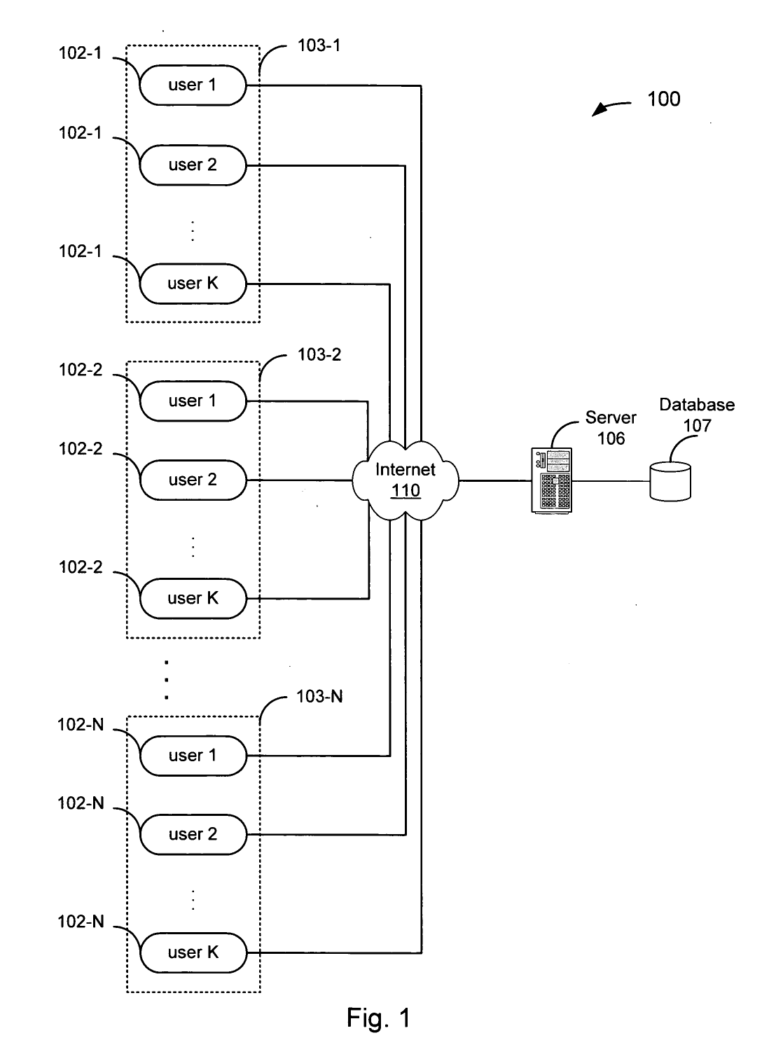

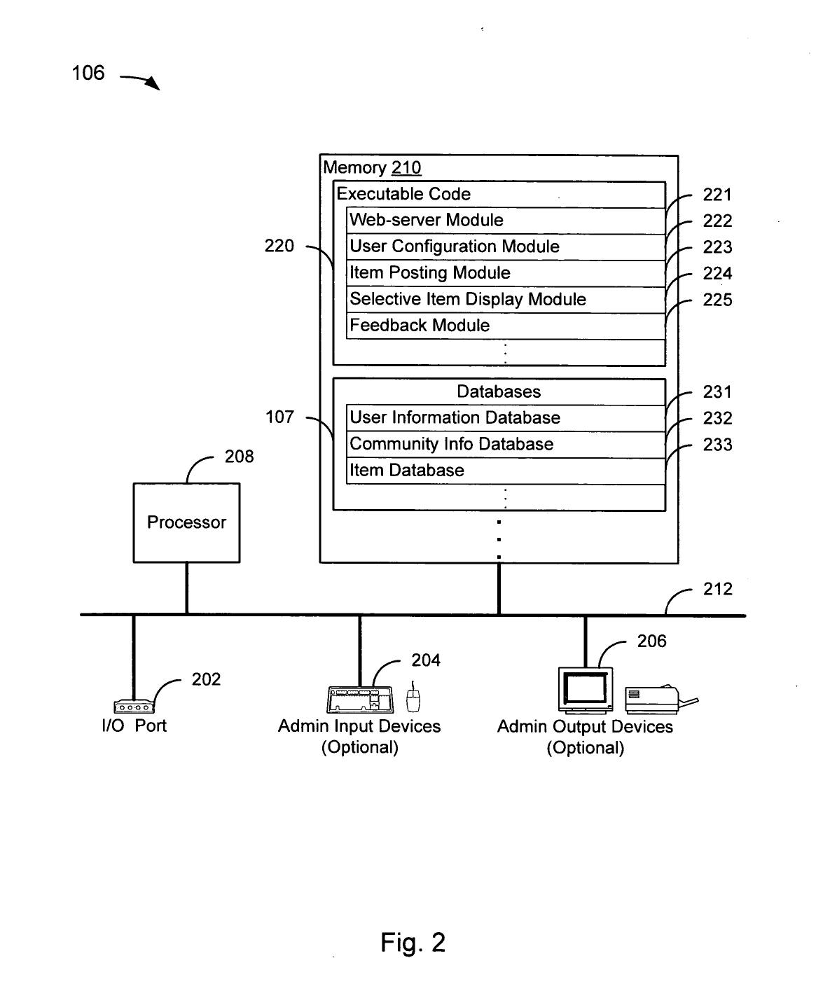

Referring now to FIG. 1, there is shown a business framework 100 on which embodiments of the invention may be practiced. The business framework 100 includes a server 106, which is accessible by users 102-1 to 102-N (collectively users 102) via a network 110, such as the Internet. The server 106 may host a database 107 on which the users can post items and in which users can browse and search the posted items. An example server 106 useful for this purpose is described in more detail with reference to an embodiment of the invention depicted in FIG. 2. Users may access the server 106 using many different types of Internet-enabled electronic devices, including computers, PDAs, and various wireless devices.

The users 102 are associated with communities 103-1 to 103-N, which are depicted as dashed boxes enclosing respective groups of the users 102. A community 103 may refer to an organization, entity or region with which a group of people may be associated. For example, users 102-1 may be residents of Ames, Iowa, and the community 103-1 may correspond to the city of Ames, Iowa, itself. As another example, users 102-2 may be students of Iowa State University at Ames, Iowa, and the community 103-2 may correspond to the Iowa State University itself.

According to one embodiment of the invention, users within the same community may access, browse or search items posted by each other. For example, items posted by one of the users 102-1 may be viewable by other users of the same community 103-1. Users not within the same community may or may not be able to access, browse or search items posted by others. For example, users 102-N of community 103-N may not be able to view items posted by users 102-1. According to the present embodiment, whether users from one community may or may not be able to access items posted by users of another community depends on the distance between the communities. If one community is “near” another community, users in these communities may be able to access items posted by each other. Two communities may be considered “nearby” if they are separated by fifty miles, for example.

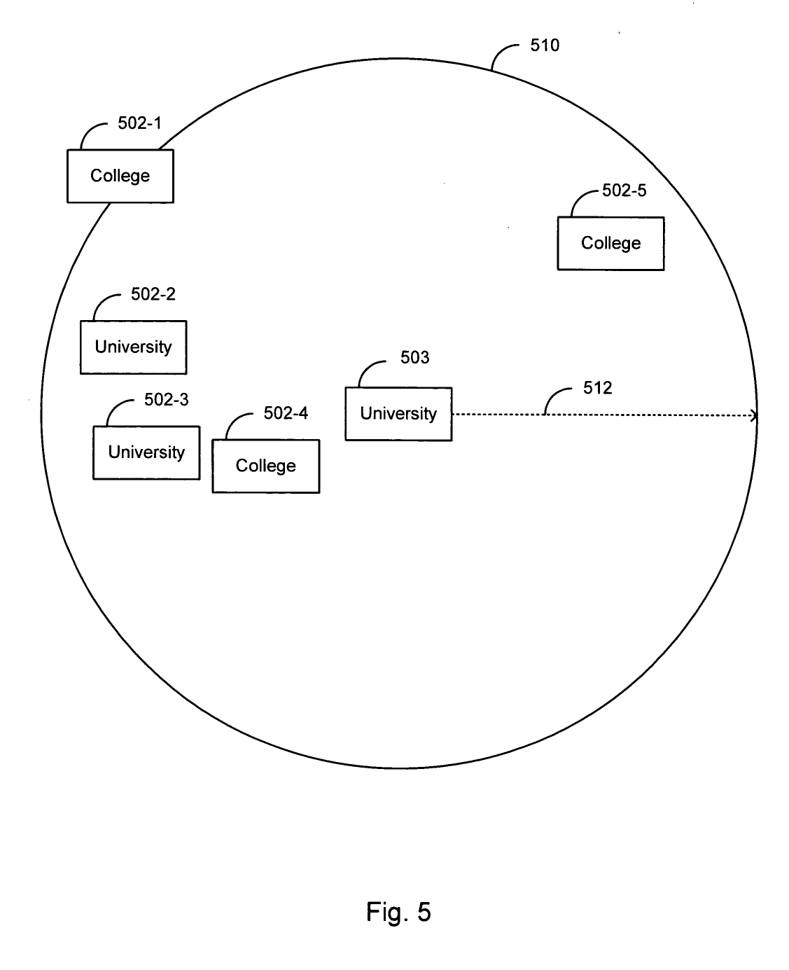

FIG. 5 depicts communities 502-1 to 502-5 that are considered to be “near” or “local” to community 503. In this embodiment, the communities 502-1 to 502-5 and 503 are colleges and universities. Communities 502-1 to 502-5 are considered to be “near” the community 503 because they fall within a region 510 defined by a predetermined distance 512, which may be fifty miles for example.

According to the business method and system of the invention, one may subdivide the entire world into a very large number of communities in which users can buy, sell, or trade items on a local level. A user in Ames, Iowa, for instance, will be able to make use of the services provided by the business framework 100 to buy, sell or trade items with others in the vicinity. At the same time, other users in Shanghai, China, may make use of the services provided by the framework 100 to buy, sell, or trade items with others in their local communities. Also note that, according to an embodiment of the invention, the business method and system does not require setting up separate online forums for each individual community. Local markets are effectively served regardless of where they are located. Local markets in different countries may be served as well.

In another aspect, the business method and system of the invention may be used to target a specific group of people with similar needs who associate themselves with something that is common to all within the group. In one embodiment, the business method and system allows a user to post an item on the online database and designate the item viewable by those who belong to a certain community of interest. For example, a user may post used college textbooks on the Web-site and designate the items as viewable by a community comprising students of nearby colleges and universities. Such postings may be more effective because they target a specific group of users more precisely than many other advertising methods. At the same time, when the postings are targeted to a specific group, user experience may improve as users will be able to find more relevant items more easily.

Other advantages of the business method and system of the invention may include:
Users interested in viewing local items may be less distracted by postings that advertise non-local items.
Transactions between sellers and buyers located near each other, particularly those transactions involving items not suitable for shipping, will be promoted.
Shipping cost can be completely avoided, thus creating additional value to the buyer and the seller.
Buyers may pick up the item posted on the Internet at the time of payment. This virtually eliminates the potential for fraud, which is inherent and unavoidable under other globally focused electronic commerce business models.
Buyers may meet the sellers to inspect (e.g., touch and feel) the items posted on the Internet before paying.
Because items for sale can be picked up, they may be available to the buyer immediately.

It should be noted that a server 106 could host one or more databases. Alternatively, in addition to the server 106, another server could host additional databases. In yet another alternative, portions of the database could be hosted by one or more servers. Multiple databases may be hosted at a single (or co-located) hosting center(s) as well.

Referring now to FIG. 2, there is shown a server 106 for use with the business framework 100 of FIG. 1. The server 106 includes an input/output (I/O) port 202, admin input devices 204, admin output devices 206, a processor 208, a memory 210, and a bus 212 that connects the components. The memory 210 includes executable code 220 and databases 107. The I/O port 202 enables communication between the server 106 and a network, such as the Internet 110 (FIG. 1). The admin input devices 204 may include a keyboard, a mouse, or other input devices. The admin output devices 206 may include a monitor, a printer, or other output devices. The admin input devices 204 and admin output devices 206 provide monitor or update information to and from the server 106. The admin input devices 204 and admin output devices 206 are optional and may be remotely located. The processor 208 runs executable code 220 in the memory 210, which may include reading and writing data to databases 107. The processor 208 may include multiple processors. The processor 208 may be a central processing unit (CPU). The memory 210 may include dynamic or static random access memory (RAM) or other types of memory. The memory 210 may further include firmware components or magnetic or optical disk storage. Applications stored in the memory 210 may be developed on J2EE compliant application components.

The executable code 220 of the memory 210 includes a Web-server module 221, a user configuration module 222, an item posting module 223, a selective item display module 224, and a feedback module 225. The databases 107 of the memory 210 include a user information database 231, a community information database 232, and an item database 233. The Web-server module 221 includes code that allows the server 106 to respond to requests from a user, such as an Internet user, and to communicate with and respond to other servers, if applicable.

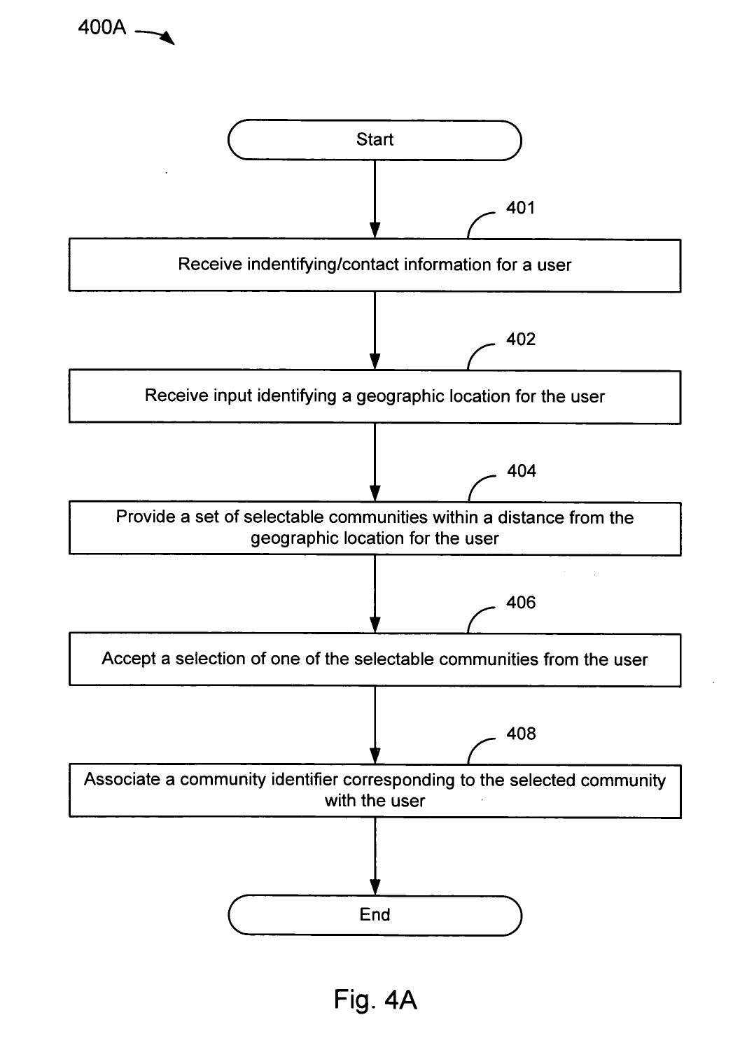

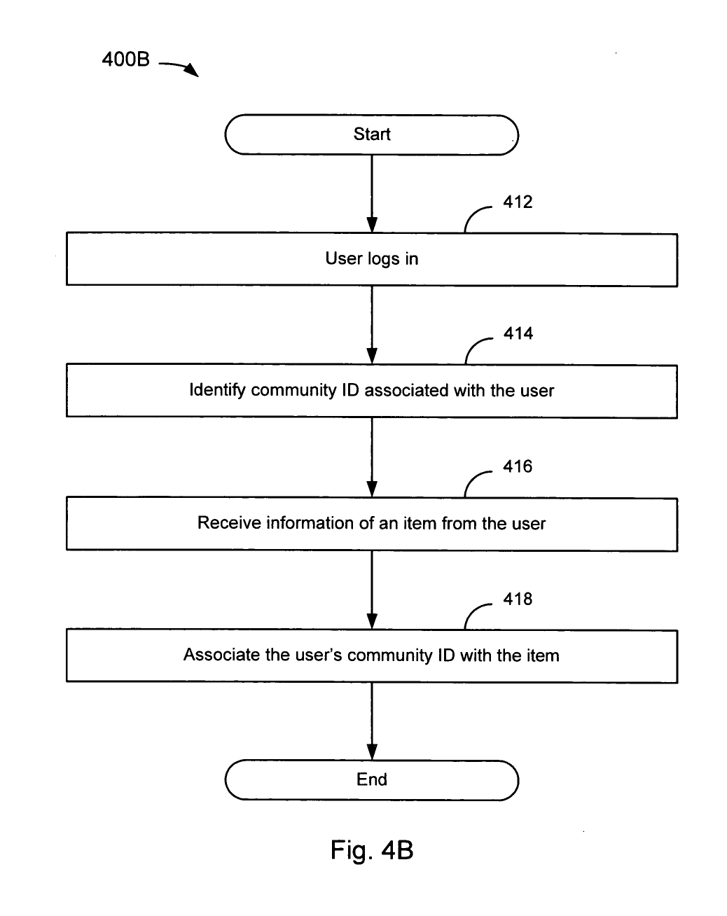

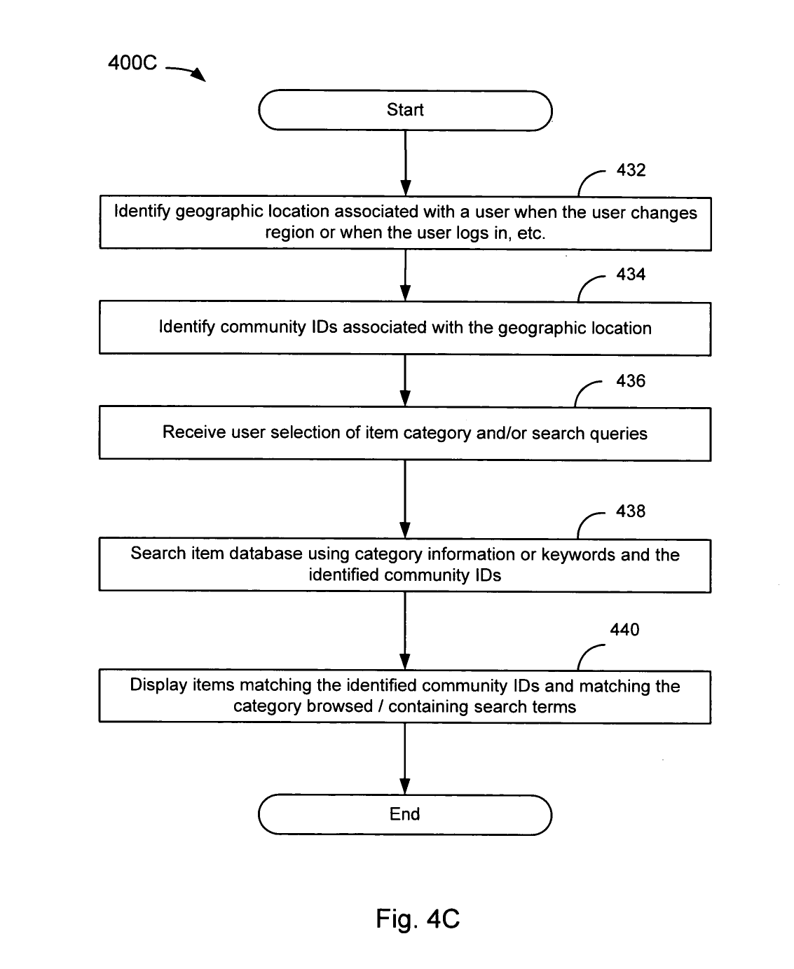

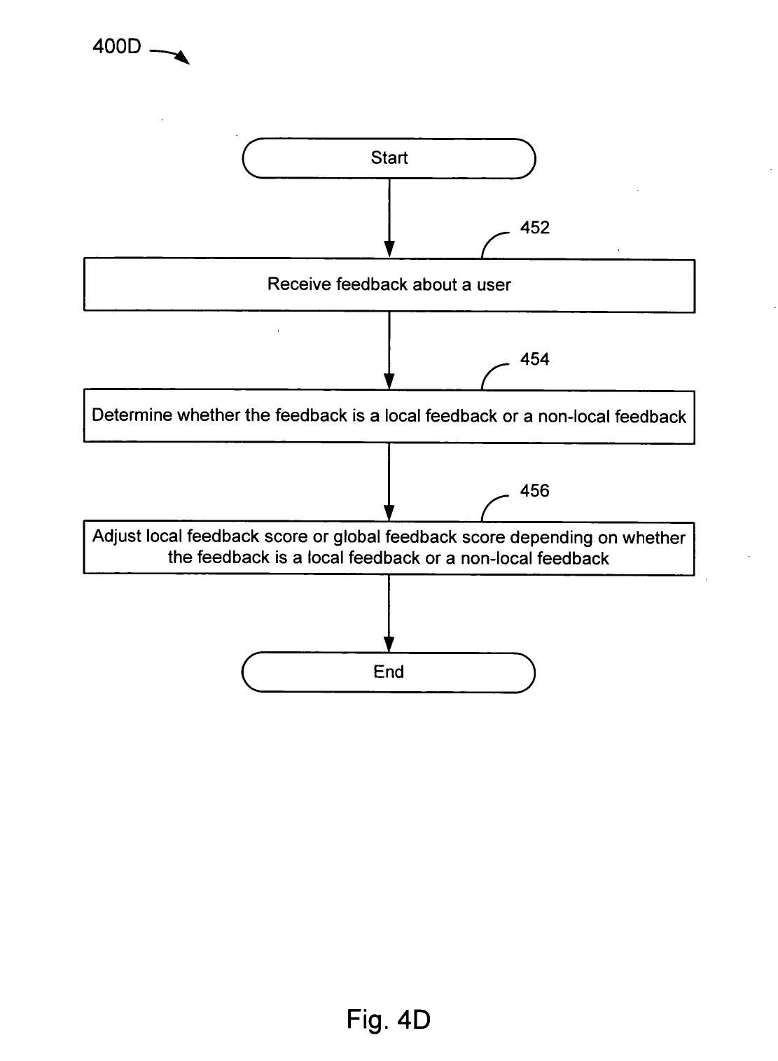

The user configuration module 222 includes code that allows the user to input or update user information in the user information database 231. In one embodiment of the invention, a user may need to register with the business framework 100 and create an account before they can post items for sale. When a user registers with the business framework 100, a user record for the user is added to the user information database 231. The user information database 231 is used to keep track of user information and activity. Furthermore, information of the user may be used to define its “home community.” For example, if the user indicates that his address is in Ames, Iowa, then his home community may be the city of Ames, Iowa, itself. And, if the user indicates that he is a student of or somehow related to Iowa State University, then his home community may be the Iowa State University itself. Users may have information entered on their behalf. For example, a university may create a user record for each new student. Note that users need not create an account before they can use the services provided by the business framework 100. For example, a user may not need to create an account in order to browse items posted by other users. That user may have to provide information regarding the location or community of interest, however. Additional functionality of the user configuration module is described later with reference to an embodiment of the invention depicted in FIG. 4A.

With reference still to FIG. 2, the item posting module 223 includes code that allows a user to create a posting to be stored in the item database 233, and code that allows the user to remove or delete a posting from the item database 233. In one embodiment, the item posting module 223 may request the user to define an item posting period after which the posting is automatically removed from the item database 233. Additional details of the item posting module 223 are described later with reference to an embodiment of the invention depicted in FIG. 4B.

With reference again to FIG. 2, the selective item display module 224 enables a user to access and view items stored in the item database 233. In one embodiment, the selective item display module 224 identifies the community with which the user is associated, and selectively displays items that are “local” to the user in response to the user's browsing and searching of items stored on the database. In one embodiment, the selective item display module 224 identifies the user's community by accessing the user information database 231. If the user is not registered, the selective item display module 224 may request the user to input a community of interest. Information that identifies the user's community may be stored as a “cookie” within the user's computer such that the user needs not re-enter the information every time he accesses the server 106. Additional details of the item posting module are described later with reference to an embodiment of the invention depicted in FIG. 4C.

According to an embodiment of the invention, the selective item display module 224 may include a browser engine that enables the users to browse selected categories of items stored on the item database 233. The selective item display module 224 further may include a search engine that enables the users to search for items using keywords, item types, item post dates, etc.

With reference still to FIG. 2, the server 106 further includes a feedback module 225, which receives and provides feedbacks. According to an embodiment of the invention, each user may be associated to two or more feedback scores. One feedback score may be associated with feedbacks from “local” users (e.g., users from the same or nearby community), and another feedback score may be associated with feedbacks from both “local” and “non-local” users. Another feedback score for feedbacks from “non-local” users may be used as well. Further details of the feedback module are described later with reference to an embodiment of the invention depicted in FIG. 4D.

According to one embodiment of the invention, the server 106 may further provide an auction module (not shown) that allows users to auction their items. In that embodiment, an auction period may be defined, and at the end of the auction period, the potential buyer with the highest bid on the item will have “won” the item. Furthermore, at the end of the auction period, the item posting module 223 may remove the item from the item database 233 automatically.

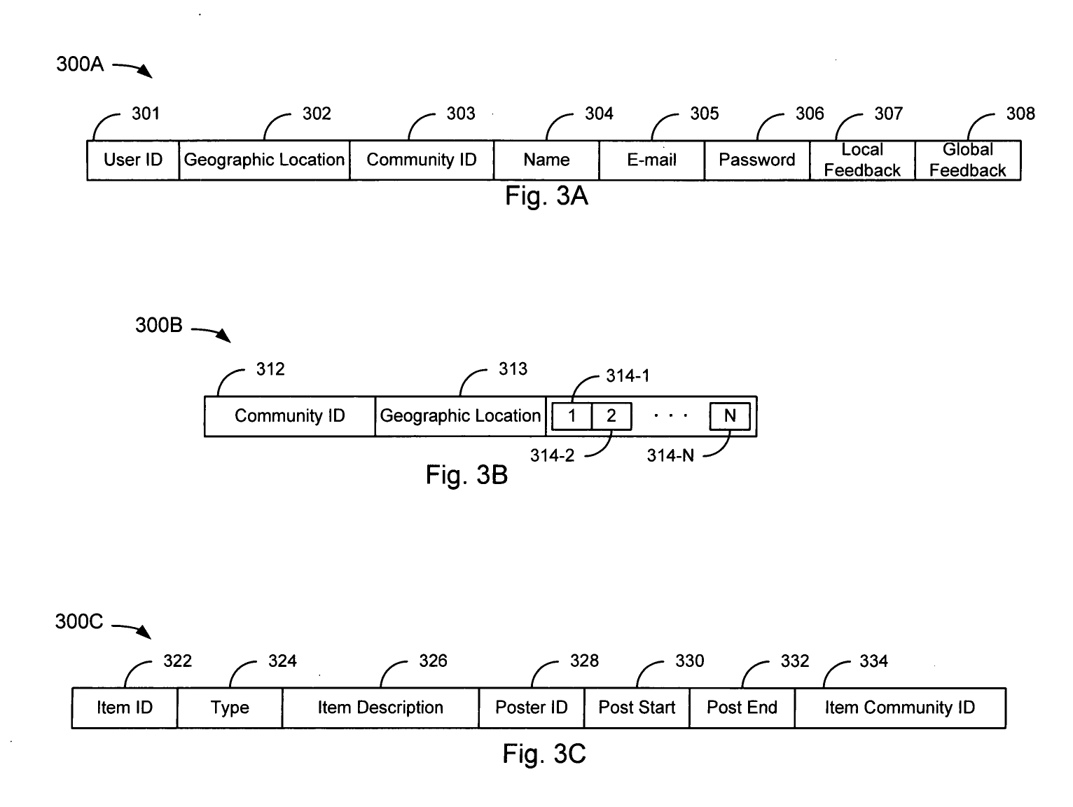

Attention now turns to FIGS. 3A-3C, which depict some example records in the user information database 231, community information database 232, and item database 233, respectively. The fields of the records are briefly described with reference to FIGS. 3A-3C, and then the use of these records is explained with reference to embodiments of the invention depicted in FIGS. 4A-4D.

FIG. 3A depicts an example user record 300A for use in the user information database 231 (FIG. 2). The user record 300A has multiple fields, including a user identifier (ID) field 301, an address field 302, a community ID field 303, a name field 304, an email field 305, a password field 306, a local feedback score field 307, and a global feedback score field 308. The user ID field 301 includes a unique identifier for the user. The geographic location field 302 includes the city, state, country, and zip code of the user's home, business, or other address. Alternatively, the geographic location may include only a phone number prefix (e.g., an area code), global position coordinates, or other geographic location identification data. The community ID field 303 identifies a community with which the user is associated. Each community may be represented by a unique community ID within the business framework 100. However, some communities may share the same community ID as well. The association of the user with the community is described later with reference to FIG. 4A. The name field 304 is for storing the user's name. The email field 305 is for storing the user's email address. The password field 306 is for storing a password for use with the user ID. The local feedback score field 307 and a global feedback score field 308 are for storing a local feedback score and a global feedback score, respectively. The feedback mechanism is described with reference to FIG. 4D.

FIG. 3B depicts an example community information record 300B for use in the community information database 232 (FIG. 2), which stores data indicating whether one community is considered “near” another community. The community information record 300B has multiple fields, including a community ID field 312, a geographic location field 313, and a list of communities 314-1 to 314-N (hereinafter referred to collectively as local communities field 314). In one embodiment, the community information record 300B may be predefined by the operator of the business framework 100.

In one embodiment of the invention, the community information database 232 may be used by the user configuration module 222 to display a list of communities near an identified geographical location. For example, when a user provides a geographic location of interest, the user configuration module 222 may display a list of colleges and universities near the geographical location. Then, the user may be prompted to select a community from the list of colleges and universities, as will be described later with reference to an embodiment of the invention depicted in FIG. 4A.

FIG. 3C depicts an example item record 300C for use in the item database 233 (FIG. 2). The item record 300C has multiple fields, including an item ID field 322, an item type field 324, an item description field 326, a poster ID field 328, a post start field 330, a post end field 332, and an item community identifier field 334. The item ID field 322 uniquely identifies an item that is posted by a user, such as when the user offers an item for sale. The item type field 324 identifies the type of transaction sought, including, but not limited to, goods, services, personals, jobs, and real estate. The item type field 324 may include subtypes. For example, goods may be for sale (a first subtype), for rent (a second subtype), wanted for sale (a third subtype), or wanted for rent (a fourth subtype); services may be offered or wanted; jobs may be for openings or resumes, etc. Types may be further categorized. Each category or type has its own unique type ID. For example, goods may be categorized into books and sub-categorized into textbooks; services may be categorized into professional services and sub-categorized into legal services; and jobs may be categorized into full-time and sub-categorized into secretarial.

With reference still to FIG. 3C, the item description field 326 may include a title for display to potential buyers and a detailed description of the item for display to potential buyers who want more information about the item. The user posting the item may provide the item type and item description, as described later with reference to FIG. 4B. The poster ID field 328 identifies the user on whose behalf an item is presented. The poster ID field 328 may include a user ID that corresponds to a record in the user information database 231. The post start field 330 may contain a start date on which the item is listed, and the post end field 332 may contain an end date on which the item will be de-listed. The item record also has an item community ID field 334, which may contain the community identifier of the poster to indicate the community at which the item is available.

With some database records of the business framework having been described, attention now turns to FIGS. 4A-4D, which depict some operations of the software modules 220 and the databases 107. FIG. 4A depicts a flowchart 400A of a process of associating a user with a community. For illustrative purposes only, the flowchart 400A is described with reference to the Web-server module 221, the user configuration module 222, the user information database 231, and the community information database 232. Since the flowchart 400A depicts a method for configuring user information, the flowchart 400A is applicable when a new user registers with the business framework 100, or when a user updates his account information. In the case of a new user registering, additional steps (not shown) may be called for, such as verifying the new user's email address, etc. Additional steps may also include arranging for payment of membership dues, authenticating credit card information, or other membership-related steps. A benefit of registration is that a registered user may post items on the Web-site. It should be noted that the flowchart 400A is optional for users who do not wish to provide user information. Nevertheless, a user may have to provide at least a geographic location (e.g., by entering a zip code while browsing) to take advantage of features of the invention.

The flowchart 400A starts at block 401 with receiving identifying/contact information for a user. A user record 300A (FIG. 3A) may be added to the user information database 231 for the user. The identifying information may include a user identifier (user ID), which may be stored in the user ID field 301 of the user record 300A. In one embodiment, the user ID may be the email address of the user. In another embodiment, the user may be permitted to choose any user ID that is not in use by a current user. The identifying information may also include the user's name, which may be stored in the name field 304 of the user record 300A. Contact information may be in the form of an email address, which may be stored in the email field 306 of the user record 300A. The user may also provide or be provided a password for use with the user ID when logging in. The password is stored in the password field 305 of the user record 300A.

The flowchart 400A continues at block 402 with receiving input that identifies a general geographic location for the user. The user configuration module 222 may prompt the user to enter, for example, a city, state, country, and zip code, which are stored in the geographic location field of the user's record 300A (FIG. 3A) in the user information database 231. In an embodiment, the user needs only enter a zip code, or city and state. Alternatives may receive from the user information such as an area code or prefix of a telephone number, nearby local landmarks, GPS coordinates, latitude and longitude, and the like, as an indication of the general location of the user.

The flowchart 400A continues at block 404 with providing a set of selectable communities within a pre-defined distance from the geographic location provided by the user. Each user record 300A (FIG. 3A) of the user information database 231 includes the geographic location field 302 and each community record 300B (FIG. 3B) of the community information database 232 includes the geographic location field 313. The geographic location field 302 and the geographic location field 313 need not have the same format, but at least a portion of each field should be comparable. For example, the geographic location field 302 may include city, state, country, and zip code while the geographic location field 313 may include only a zip code. The zip code of the geographic location field 302 may be compared to the zip code of the geographic location field 313 to retrieve a list of local communities 314, such as a list of colleges and universities around that area. The Web-server module 221 may present the list as a set of selectable communities to the user so that the user can choose the nearby community with which he or she wishes to be associated.

As discussed earlier, the set of selectable communities may include entities with which a group of people may be associated and which are located within a pre-defined distance from the user's geographic location. For example, with reference to FIG. 5, when a user whose location is within the region 510, he may be presented with a list of communities 502-1 to 502-5 and 503, and the user may choose one of these communities to be associated therewith.

Referring once again to FIG. 4A, the flowchart 400A continues at block 406 with the user configuration module 222 accepting a selection of one of the selectable communities from the user.

The flowchart 400A ends at block 408 with associating the selected community with the user. According to one embodiment, if the list of selectable communities is empty, or if the user does not choose a community from the list, a community ID corresponding to the zip code of the geographic location field 302 may be stored in the community ID field 303. If the user chooses a community from the list, a community ID corresponding to the selected community may be stored in the community ID field 303. The user configuration module 222 stores the community ID for the selected community in the user's community ID field 303. In this way, the user becomes associated with the selected community. In some embodiments, the Web-server module 221 may store the community ID directly to the user information database 231 without invoking the user configuration module 222. According to an embodiment of the invention, all items posted by a user will automatically inherit the user's community ID, unless the user specifies otherwise.

FIG. 4B depicts a flowchart 400B of a process of posting items in the business framework 100 according to an embodiment of the invention. For illustrative purposes only, the flowchart 400B is described with reference to the Web-server module 221, the item posting module 223, the user information database 231, the community information database 232, and the item database 233. The flowchart 400B starts at block 412 with a user logging on to the business framework 100 and continues at block 414 with identifying the community information of the user. In one embodiment, the community information may be retrieved from the community ID field 303 of the user's record in the user information database 231. In one embodiment, a new user may be requested to set up an account with the business framework 100, an example process of which has been described with reference to FIG. 4A, before he can post an item.

The flowchart 400B continues at block 416 with receiving item information from the user. Item information may include a title (the portion of item description that is later displayed to potential buyers), description (the portion of the item description that provides more detailed information about the item), category, and other related information. The item may be represented in the item database 233 with an item record 300C (FIG. 3C). When item posting module 223 receives item information, it assigns the item an item ID, which may be stored in the item ID field 322 of the item's record 300C in the item database 233. The item received may also include (or otherwise be assigned) an item type (which may include a category), which may be stored in the item type field 324, and an item description, which may be stored in the item description field 326. The poster is identified in the poster ID field 328. The item may be given a timestamp, which may be stored in the post start field 330. The item may be assigned a date some pre-determined time in the future (e.g., one month after the post starts) as the expiration date of the post, which is stored in the post end field 332. The user may specify the post start date, post end date, or both.

The flowchart 400B ends at block 420 with associating the user's community ID with the item. In one embodiment, the community ID of the user, which is identified at block 414 above, may be stored in the item community ID field 334.

Even though an item is associated with a community ID, it does not mean that the item may be viewed by users sharing the same community ID only. Rather, the item may be viewed by those who share the same community ID and by those who have community IDs corresponding to nearby communities. Referring once again to FIG. 5, and assuming that the user is associated with the community 503, the items posted by the user may be viewed by those associated with communities 502-1 to 502-5. In addition, all users associated with other communities located within the area 510 may view the item as well.

FIG. 4C depicts a flow chart 400C for a item display mechanism according to an embodiment of the invention. For illustrative purposes only, the flowchart 400C is described with reference to the Web-server module 221, the selective item display module 224, the user information database 231, the community information database 232, and the item database 233.

As shown, the flowchart 400C starts at block 432 with the Web-server module 221 identifying a geographic location associated with a user when the user initiates a session with the server 106 or changes region. In one embodiment, the user may have used the business framework before and may have a “cookie” stored on the user's device, and the “cookie” may indicate the user's community of interest during a previous session. In that case, the Web-server module 221 may retrieve such information from the “cookie” and may use such information in the current session. Alternatively, the user may be required to log on to his account, and/or the user may be prompted to enter a geographic location or a community of interest.

In one embodiment, when the user provides a geographic location (e.g., a zip code), the user may be presented with a list of selectable communities near the user's geographic location (e.g., a list of colleges and universities in or near the zip code) from which the user may choose as his community of interest.

The flowchart 400C continues at block 434 with the selective item display module 224 identifying one or more community IDs associated with the geographic location or community of interest of the user. In one embodiment, this step may be carried out by accessing information contained within the community information database 232. Typically multiple community IDs may be obtained.

The flowchart 400C continues at block 436 with receiving the user's selection of item category that he desires to browse, or the user's keywords if the user desires to use search engine functionality of the selective item display module 224.

The flow chart 400C continues at block 438 with the selective item display module 224 searching the item database 233 using the information received from the user and the community IDs identified in block 434 as search criteria. Preferably, only items meeting all of the search criteria are returned. In another embodiment, items that partially meet the search criteria are returned, and a ranking engine may be used to rank the relevancy of the search results. If a ranking engine is used, the community IDs may be given more weight such that items not matching the community Ids are displayed later.

The flow chart 400C ends at block 440 with the selective item display module 224 displaying items matching the search criteria. In one embodiment, only items meeting all of the search criteria are displayed. In another embodiment, items that partially meet the search criteria are displayed, but the more relevant items may be displayed first, according to the ranking results produced by a ranking engine.

FIG. 4D depicts a flowchart 400D for a feedback mechanism according to an embodiment of the invention. After a transaction, the feedback module 225 may direct the Web-server module 221 to prompt the parties to a transaction for feedback. The feedback may be in the form of a “feedback score,” where one point will be given to the reviewee if the review is favorable, and where one point will be taken from the reviewee if the review is unfavorable. Note that, in one embodiment of the invention, the user may have a local feedback score and a global feedback score. A user's local feedback score reflects the feedback given by reviewers within the same or nearby communities, while the user's global feedback score reflects the feedback given by reviewers regardless of whether they are local or non-local to the reviewee. In one embodiment, the local feedback score and the global feedback score may be stored within a user record 300A (FIG. 3A) of the user information database 231 in their respective fields.

The flowchart 400D starts at block 452 with receiving feedback about a user. This feedback, for instance, may come from the buyer of an item. The feedback may come from a seller as well.

The flowchart 400D continues at block 454 with determining whether the feedback is a local feedback or a global feedback. The feedback module 225 checks the community ID field 306 of the user record of the reviewer, looks up the community ID field of the user record of the reviewee, and determines whether the reviewer and the reviewee are in the same or nearby community. In one embodiment, this step may involve the use of the community information database 232, which may contain the necessary information for such a determination.

The flowchart 400D ends at block 456 with adjusting the local feedback score or the global feedback score of the reviewee depending on whether the feedback is a “local” feedback or a “non-local” feedback.

Some sellers may be more accessible in closer communities than in those farther away. The disparity in quality of service based on the community wherein the transaction takes place may be an important consideration for some buyers. Moreover, feedback may make flooding positive feedback by allies (or negative feedback by enemies or competitors) more difficult because you must be a user of the community to provide feedback. Thus, community feedback may be more accurate than global feedback.

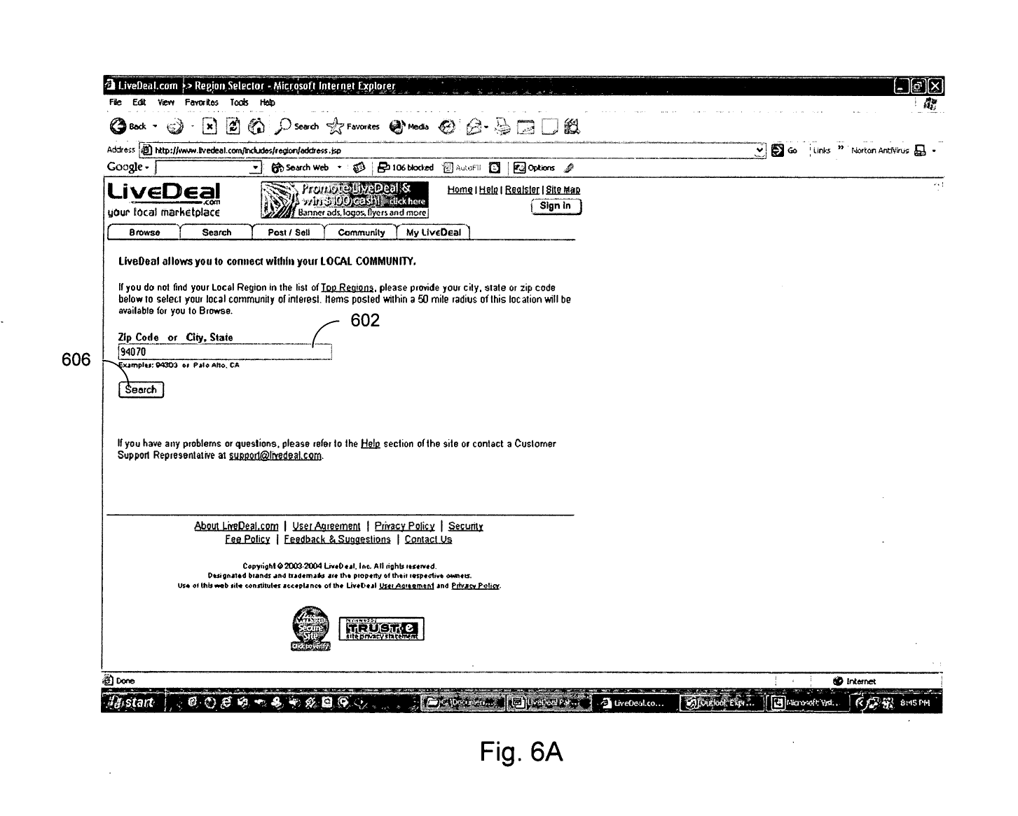

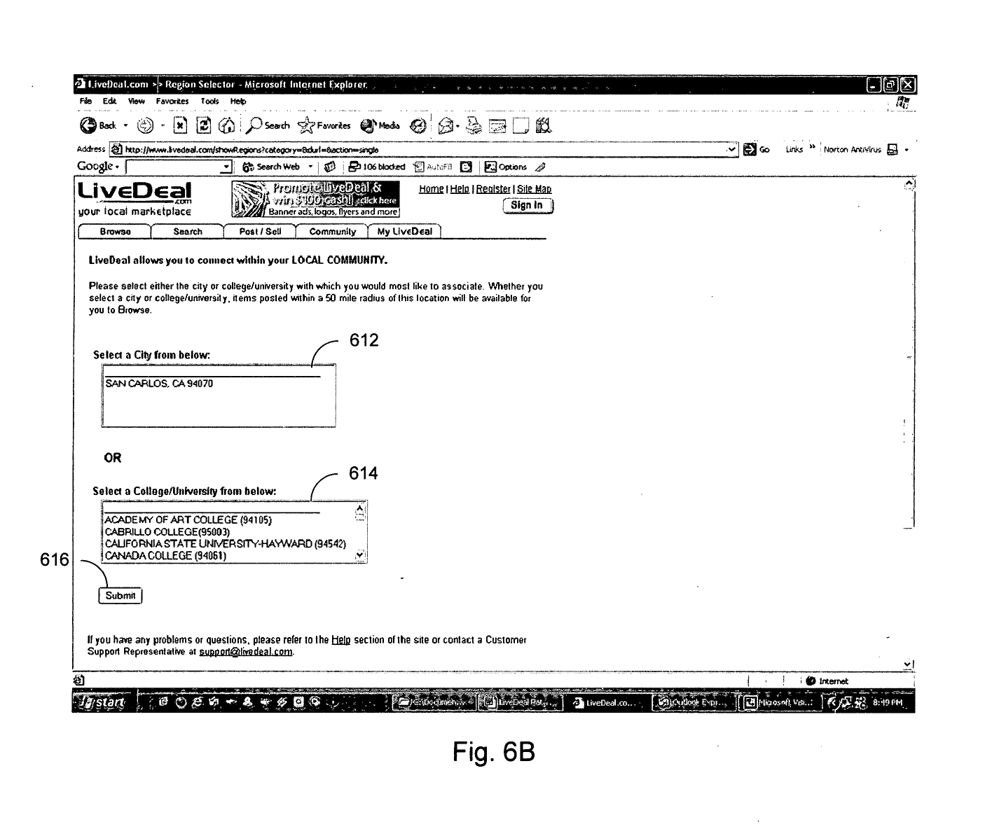

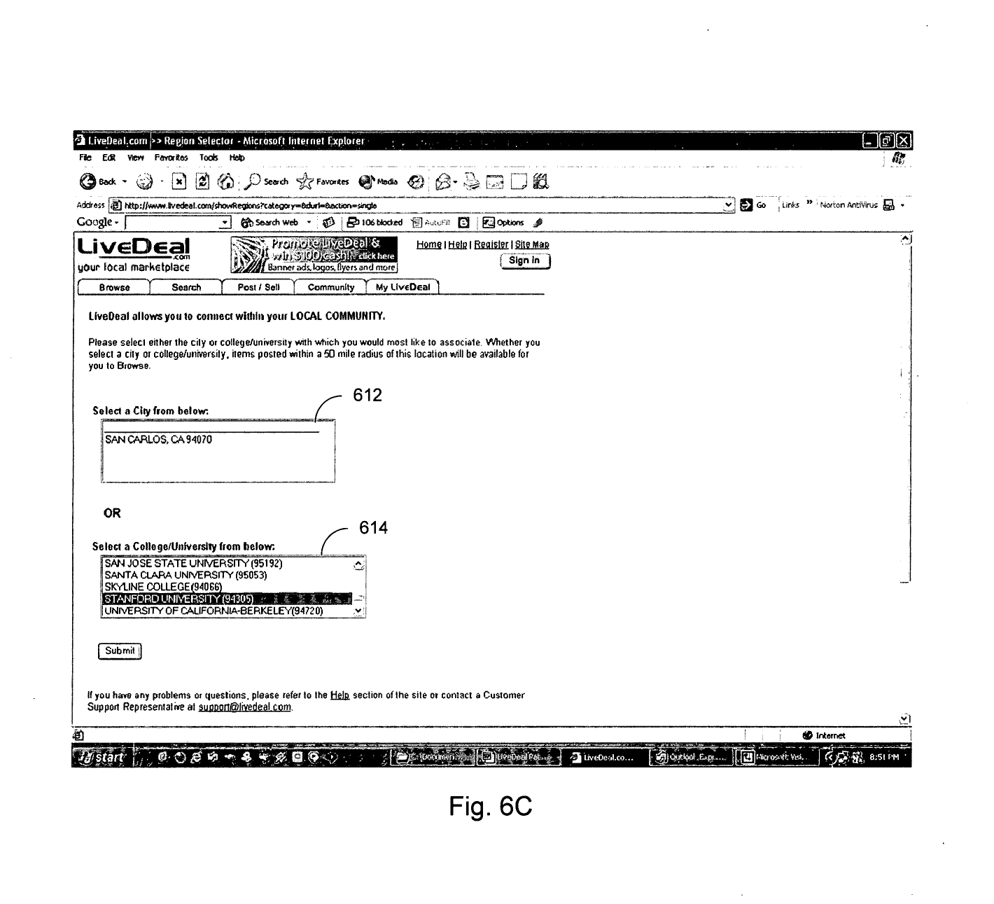

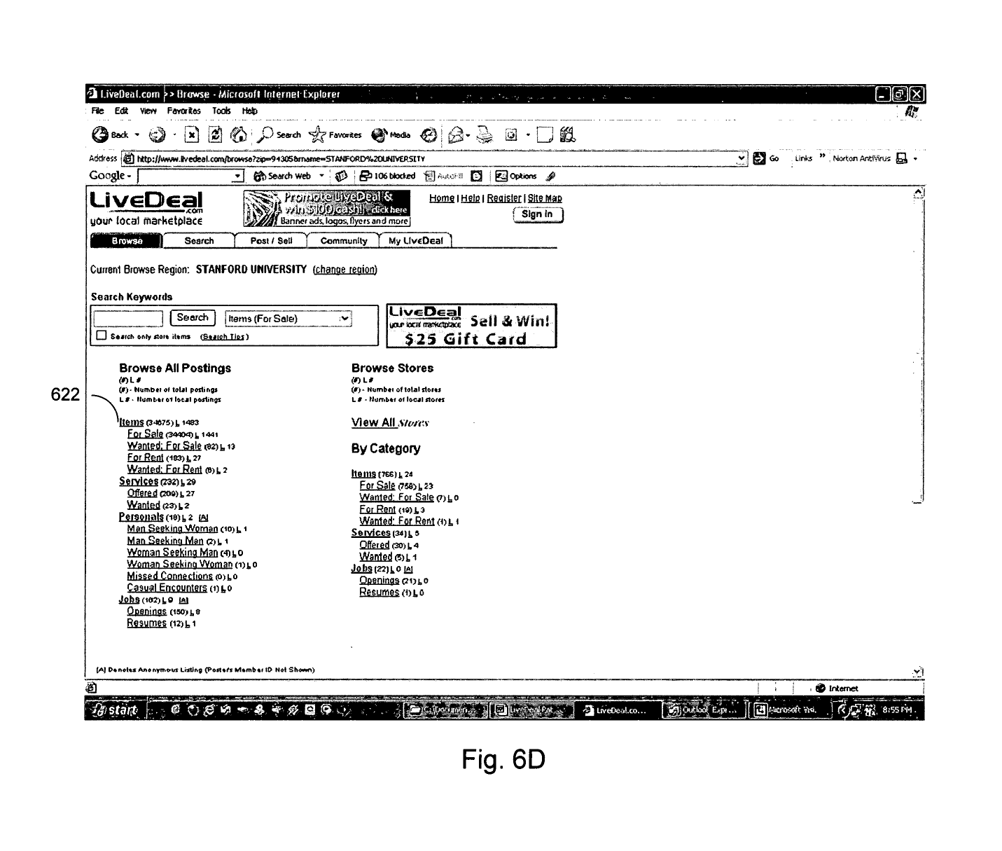

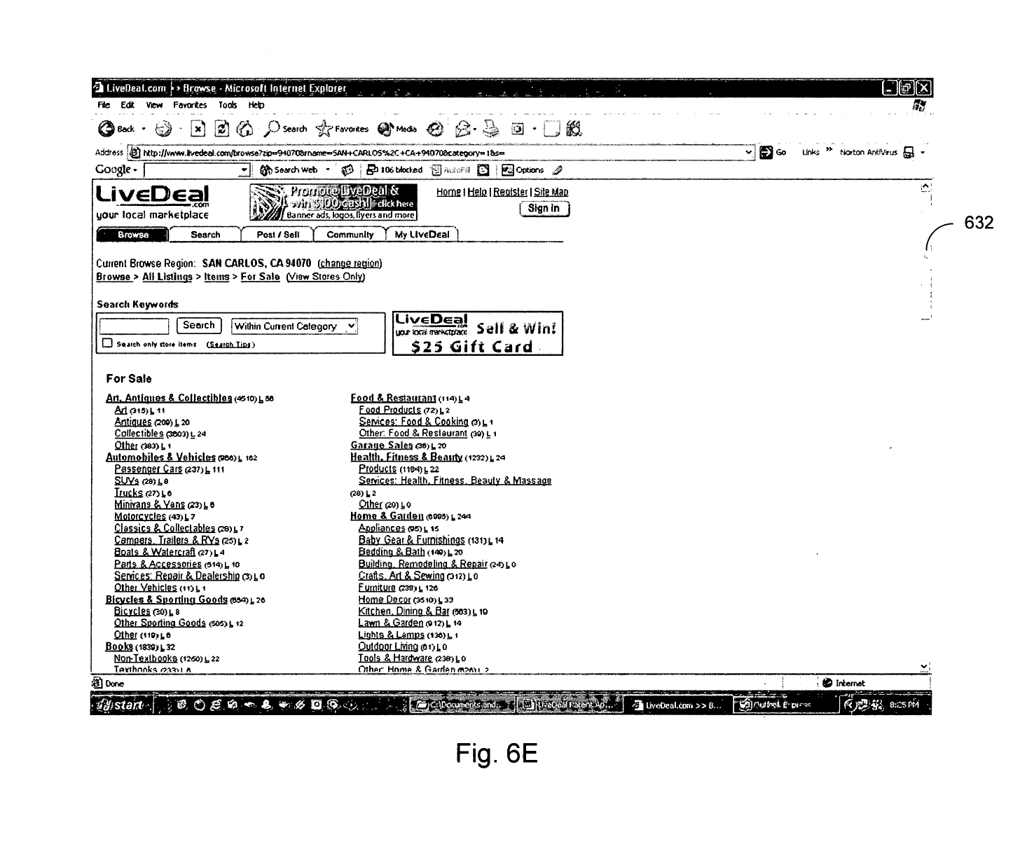

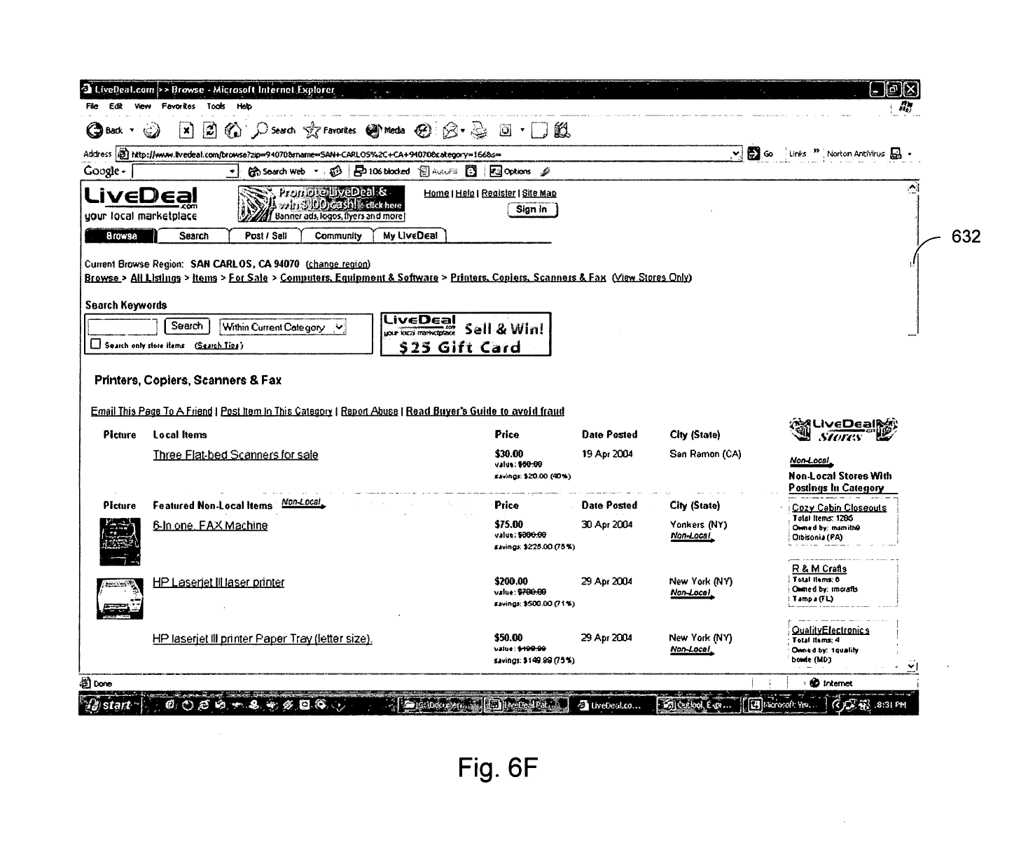

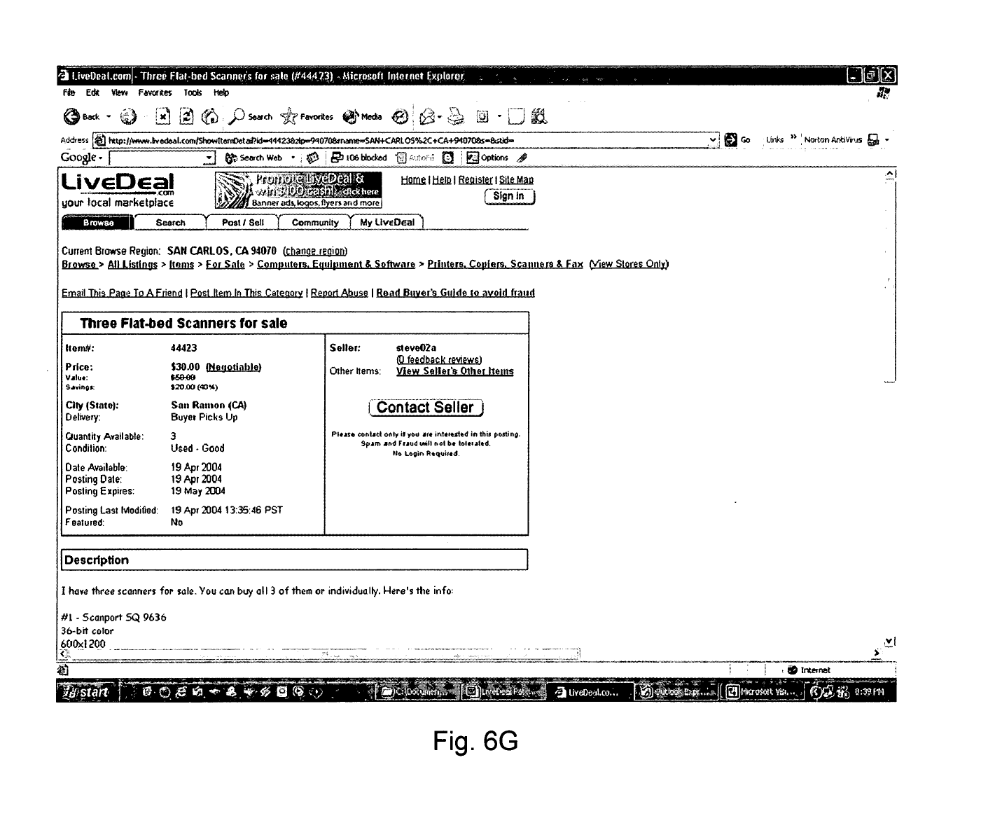

FIGS. 6A to 6G depict screenshots from a Web site according to an embodiment of the invention. The screenshots are intended to illustrate a Web experience for an Internet user who attempts to find a scanner for sale locally using the Web site.

FIG. 6A depicts a screenshot related to establishing the general location of a user. By establishing a general location, the system can determine which local communities are near the user's general location and provide a list of local communities from which to choose. In the example of FIG. 6A, the user is prompted to provide a zip code or city, state. For illustrative purposes, the user has entered the zip code “94070” in the text box 602. When the Internet user clicks on the search button 606, the screen depicted in FIG. 6B comes up.

FIG. 6B depicts a screenshot related to providing a set of selectable communities for the user. In one embodiment of the invention, the set of selectable communities are generated from the general location of the user. In the example of FIG. 6B, the user is given the option of selecting a city from the selectable list 612 or selecting a college or university from the selectable list 614. Note that the selectable list 612, in this example, includes only one entry, but it is nevertheless referred to as a list. When the Internet user selects a community to be associated with, the screen looks like, for example, the screenshot depicted in FIG. 6C.

FIG. 6C depicts a screenshot much like that of FIG. 6B where, for the purposes of example, Stanford University (94305) has been selected from the selectable list 614. The number in parenthesis is the zip code of the local community. After selecting a local community, when the user clicks on the submit button 616 the screen depicted in FIG. 6D comes up.

FIG. 6D depicts a screenshot related to browsing for items, services, personals, and jobs. In the example of FIG. 6D, the total numbers of global and local posts are displayed to the right of postings and categories. When the user clicks on, for example, Items For Sale 622, then the screen depicted in FIG. 6E comes up.

FIG. 6E depicts items for sale by category. If the user scrolls down the page using the scrollbar 632 (or some other means, such as an arrow key or scroll wheel of a mouse) and selects for example “Printers, Copiers, Scanners & Fax” (not shown), then the screen depicted in FIG. 6F may come up.

FIG. 6F depicts, for example, items that are “Local Items” or items that have been posted by another user in a nearby community. If the user selects, for example, “Three Flat-bed Scanners for sale”, then an entry related to the selection is displayed, such as is depicted in FIG. 6G. At this point, the user may consider contacting the party offering the item, or continue browsing for a different item.

While the invention has been described and shown in connection with the preferred embodiments, it is to be understood that modifications may be made without departing from the spirit thereof. The embodiments described are by way of example and should not be construed as limiting of the claims except where referenced to the specification is required for such construction. For instance, it should also be understood that throughout this disclosure, where a software process or method is shown or described, the steps of the method may be performed in any order or simultaneously, unless it is clear from the context that one step depends on another being performed first. It should be understood by those skilled in the art upon reading the present disclosure that software processes, which have been described as client-side processes (e.g., those running on the presentation devices), can be performed as server-side processes (e.g., those running on a server), and vice versa, when appropriate. Elements of the invention may be implemented through computer program(s) operating on one or more general purpose computer systems or instruction execution systems such as personal computers or workstations, cable TV set-top boxes, satellite TV set-top boxes, computer gaming systems, video-phone systems, mobile systems (e.g., mobile computers, wireless telephones, personal digital assistants) or other microprocessor-based platforms. Furthermore, claims that do not contain the terms “means for” and “step for” are not intended to be construed under 35 U.S.C. § 112, paragraph 6.

1. A method of facilitating community-based and location-based transactions, comprising:
storing a plurality of postings within a database that is accessible via a network, the postings being associated with a plurality of communities; and
providing information of the postings to users who access the database, wherein the providing step comprises:
receiving information from a first user, the information indicating a first community with which the first user is associated without requiring the first user to choose the first community from a list of pre-defined geographical areas; and
selectively displaying postings that are associated with communities within a pre-defined distance from the first community, without displaying postings that are associated with communities located more than the pre-defined distance away from the first community.

2. The method of claim 1, wherein the plurality of communities correspond to a plurality of geographical locations.

3. The method of claim 1, wherein the plurality of communities include an entity with which a group of people is associated.

4. The method of claim 3, wherein the providing step comprises:
receiving input identifying a geographic location from the first user;
providing the first user a set of selectable communities within a distance from the geographic location;
accepting a selection of one of the selectable communities from the first user; and
assigning a community identifier corresponding to the selected community to the first user.

5. The method of claim 1, wherein the providing step comprises:
providing a number of postings that are associated with the first community or a local community for each of a plurality of categories of items; and
providing a total number of postings for each category.

6. The method of claim 1, wherein the storing step comprises:
receiving input identifying a geographic location from a user;
providing the user a set of selectable communities within a distance of the geographic location;
accepting a selection of one of the selectable communities from the user;
receiving a posting from the user; and
storing the posting in the database in association with a community identifier that is associated with the selected community.

7. A computer system comprising a memory and a processor operable to run executable code in said memory, said executable code comprising:
a module for storing a plurality of postings within a database, the postings being associated with a plurality of communities;
a data access module for providing information of the postings to users who access the database, wherein the data access module comprises:
a module for receiving from a first user information that indicates a first community with which the first user is associated without requiring the first user to choose the first community from a pre-determined list of geographical areas; and
a module for selectively providing information of postings that are associated with communities within a pre-defined distance from the first community, without displaying postings that are associated with communities located more than the pre-defined distance away from the first community.

8. The system of claim 7, wherein the plurality of communities correspond to a plurality of geographical locations.

9. The system of claim 7, wherein the plurality of communities each include an entity with which a group of people is associated.

10. The system of claim 7, further comprising a user configuration module for:
receiving input identifying a geographic location for a user;
providing to the user a set of selectable communities within a distance from the geographic location;
accepting a selection of one of the selectable communities by the user; and
assigning a community identifier associated with the selected community to the user.

11. The system of claim 10, wherein said data access module is further for:
receiving a posting from the user; and
storing the posting in the database in association with the assigned community identifier.

12. The system of claim 7, wherein said user access module is further for:
providing a number of postings that are associated with the first community or a local community for each of a plurality of categories of items; and
providing a total number of postings for each category.

13. The system of claim 7, further comprising a user information database for storing each one of a plurality of user records in association with a community identifier.

14. The system of claim 7, further comprising a posting database for storing each one of a plurality of postings in association with a community identifier.

15. A computer program product comprising a computer-readable medium having computer program instructions stored therein which are operable to cause a computer device perform a method of facilitating community-based and location-based transactions, the computer program instructions comprising:
computer program instructions to cause the computer device to receive and store a plurality of postings within a database that is accessible via a network, the postings being associated with a plurality of communities;
computer program instructions to cause the computer device to provide information of the postings to users who access the database;
computer program instructions to cause the computer device to receive information from a first user, the information indicating a first community with which the first user is associated, without requiring the first user to choose the first community from a pre-determined list of geographical areas; and
computer program instructions to cause the computer device to selectively provide information of postings that are associated with communities within a pre-defined distance from the first community, without displaying postings that are associated with communities located more than the pre-defined distance away from the first community.

16. The computer program product of claim 15, wherein the plurality of communities correspond to a plurality of geographical locations.

17. The computer program product of claim 15, wherein the plurality of communities each include an entity with which a group of people is associated.

18. The computer program product of claim 15, further comprising:
computer program instructions to cause the computer device to receive input identifying a geographic location for a user;
computer program instructions to cause the computer device to provide to the user a set of selectable communities within a distance from the geographic location;
computer program instructions to cause the computer device to accept a selection of one of the selectable communities by the user; and
computer program instructions to cause the computer device to assign a community identifier associated with the selected community to the user.

19. The computer program product of claim 18, further comprising:
computer program instructions to cause the computer device to receive a posting from the user; and
computer program instructions to cause the computer device to store the posting in the database in association with the assigned community identifier.

20. The computer program product of claim 15, further comprising:
computer program instructions to provide a number of postings that are associated with the first community or a local community for each of a plurality of categories of items; and
computer program instructions to provide a total number of postings for each category.
